(19) United States
(12) Patent Application Publication
(10) Pub. No.: US 2014/0267595 A1
(43) Pub. Date: Sep. 18, 2014

(54) ROTATING SURVEILLANCE CAMERA

(71) Applicant: Mark J. Cuddeback, Green Bay, WI (US)

(72) Inventor: Mark J. Cuddeback, Green Bay, WI (US)

(21) Appl. No.: 14/210,930

(22) Filed: Mar. 14, 2014

Related U.S. Application Data
(60) Provisional application No. 61/790,884, filed on Mar. 15, 2013.

(51) Int. Cl. H04N 7/18; H04N 5/232; H04N 5/374; H04N 5/225

(52) U.S. Cl. CPC H04N 7/183; H04N 5/2251; H04N 5/23238; H04N 5/374
USPC 348/37

(57) ABSTRACT

The present invention provides a camera assembly operable to capture a surrounding scene. The camera assembly comprises a rotatable structure, a motor assembly operable to rotate the rotatable structure, a camera coupled to the rotatable structure, and a controller operable to control the motor assembly synchronous with the imaging device such that the linear device captures the image while the motor is rotating the camera. The imaging device can include a linear optical array (e.g., a CMOS image sensor). In one embodiment, the controller is programmed to rotate the camera at least 300 degrees, and preferably about 360 degrees. If desired, the amount of rotation of the camera is adjustable. For example, the camera assembly can further include an indicator (e.g., a magnet) that determines an amount of rotation of the camera, and a position of the indicator can be adjusted to change the amount of rotation of the camera.

### BACKGROUND

The present invention relates generally to surveillance cameras, which are cameras used to capture activity in a remote location without the presence of a user. More specifically, the invention relates to a rotating surveillance camera.

Surveillance cameras are often used by hunters to determine the amount of animal activity at a remote location. However, it is hard to predict in which direction the animal activity will be, and traditional cameras have a limited field of view when taking pictures. Therefore, activity may be missed and not photographed if the activity is happening outside the camera's field of view.

### SUMMARY

The present invention provides a camera assembly operable to capture a surrounding scene. The camera assembly comprises a rotatable structure, a motor assembly operable to rotate the rotatable structure, a camera (e.g., a digital camera having a lens and an imaging device configured to record a portion of the surrounding scene) coupled to the rotatable structure, and a controller operable to control the motor assembly synchronous with the imaging device such that the linear device captures the image while the motor is rotating the camera. The assembly can further include a support coupled to and supporting the motor assembly and rotatable structure, and the motor assembly can include a motor base secured to the rotatable structure and a motor shaft secured to the support. The imaging device can include a linear optical array (e.g., a CMOS image sensor).

In one embodiment, the controller is programmed to rotate the camera at least 300 degrees, and preferably about 360 degrees. Such rotation is preferably at a substantially constant speed, such as from 10 to 360 degrees per second. If desired, the amount of rotation of the camera is adjustable. For example, the camera assembly can further include an indicator (e.g., a magnet) that determines an amount of rotation of the camera, and a position of the indicator can be adjusted to change the amount of rotation of the camera. Preferably, there are two indicators attached to a stationary support, and the position of at least one of them is adjustable.

Other aspects of the invention will become apparent by consideration of the detailed description and accompanying drawings.

### BRIEF DESCRIPTION OF THE DRAWINGS

FIG. 1 is a perspective view of a surveillance camera assembly embodying the present invention.

FIG. 2 is a front view of the camera assembly of FIG. 1.

FIG. 3 is a section view taken along line 3-3 in FIG. 2.

FIG. 4 is a schematic illustration of connections of the camera assembly of FIG. 1.

FIG. 5 illustrates a scene to be captured by the camera assembly of FIG. 1.

FIG. 6 is the resulting panoramic photograph of the scene of FIG. 5, captured by the camera assembly of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

FIGS. 1-3 illustrate a wildlife surveillance system, or camera assembly 10 that can be attached to a mounting structure (e.g., a post). The camera assembly 10 includes a support 12, a camera housing 14, and a motor assembly 16 connecting the camera housing 14 to the support 12. The camera housing 14 contains a digital camera 18, a lighting system 20 in the form of LEDs 22, and a passive infrared motion sensor 24.

The digital camera 18 includes a lens 26 and linear, two-dimensional Complementary Metal-Oxide-Semiconductor (CMOS) image sensor, or linear optical array 27. The linear optical array 27 is configured to convert incoming light from a narrow field of view (e.g., 1 degree wide by 40 degrees high) into image data. It is noted, however, that the digital camera 18 could be a standard pixelated camera with suitable image-processing software.

The motor assembly 16 is an electric motor that includes a motor base 28 secured to the camera housing 14 and a motor shaft 30 secured to the support 12. As a result of this arrangement, rotation of the motor shaft 30 relative to the motor base 28 results in rotation of the camera housing 14 relative to the support 12.

The camera assembly further includes a position sensor 32 coupled to the camera housing 14 for rotation with the camera housing 14. Indicators 34 are coupled to the support 12 and are sensed by the position sensor 32 in order to provide the position sensor 32 with an indication if its position relative to the support 12. In the illustrated embodiment, one indicator 34 establishes the starting position for the image-capturing process, and the other indicator 34 established the stopping position for the process. In the illustrated embodiment, the indicators 34 are magnets that are magnetically held in place on the support 12. The position of the indicators 34 can be adjusted by the user in order adjust the number of degrees over which an image will be taken.

The above-referenced components are electrically coupled to a controller 36 (e.g., a printed circuit board including a digital signal processor) so that information and commands can be passed to and from the controller 36. For example, the motion sensor 24 will detect movement of an object and provide that information to the controller 36, and the position sensor 32 will detect its position relative to the indicators 34 and provide that information to the controller 36. In addition, the controller 36 can send commands to the lighting system 20 and digital camera 18 to initiate the capturing of an image, and the controller 36 can also send a command to activate the motor assembly 16 and initiate rotation of the camera housing 14 relative to the support 12.

The camera assembly 10 further includes a power source 38 (e.g., batteries—FIG. 3) that provides power to the controller 36, the digital camera 18, the lighting system 20, and the motor assembly 16.

The image data is received by the controller 36. As the camera housing 14 is rotated, the controller 36 combines the linear image output of the linear image sensor into a continuous 360-degree image. The controller 36 saves the continuous 360-degree image (i.e. panoramic photo) onto a storage media 40 (e.g., a SD card).

The camera assembly 10 can be controlled in one of at least two operating modes. The first operating mode is a time lapse mode where the camera assembly 10 records a panoramic photograph every predetermined time period (e.g., take a panorama every 15 seconds, or 30 minutes). In this mode, the controller 36 includes an internal clock 42 and can be programmed to initiate the image-capturing process at certain intervals. Upon determining that an image should be captured, the controller 36 sends signals to activate the motor and to initiate capturing an image by the digital camera 18. As the digital camera 18 captures the image, the digital camera 18 is being rotated to create a panoramic image. The rotational speed of the digital camera 18 is substantially constant for a given image-capturing process, preferably at an angular speed of about 10 to 300 degrees/second or more. When the position sensor 32 encounters the indicator 34, the controller 36 stops the motor and terminates the image capturing process.

The second operating mode is a trigger mode where the motion detector sends a signal to the controller 36 when motion is detected. Upon receipt of this signal, the controller 36 initiates the image-capturing process, which is performed generally as noted above.

A scene to be captured by the camera assembly 10 is illustrated from a top perspective view in FIG. 5. The camera assembly 10 is located in the middle of the scene with scenic elements 50, 52, 54, 56 located in different directions with respect to the camera assembly 10. In operation, the camera begins taking a photo after a predetermine time period or after motion has been detected, depending on the operating mode of the camera assembly 10. When the camera begins taking a photo, the linear image sensor begins recording the narrow field of view. While taking a photo, the linear image sensor is rotated clockwise to capture narrow portions of the entire scene. Simultaneously, the control unit is controlling the motor to rotate the linear image sensor at an appropriate rate to ensure the capture of a quality image. The narrow portions captured by the linear image sensor are received by the control unit, and merged together to create a panoramic image illustrated in FIG. 6. The panoramic image includes all of the scenic elements 50, 52, 54, 56. The scenic elements 50, 52, 54, 56 appear in a linear fashion (e.g., from left to right) with the element 50 that the linear image sensor encountered first during clockwise rotation, appearing first in the photo. Similarly, as the linear image sensor continues to rotate clockwise, the linear image sensor records the scenic element 52, followed by scenic element 54, and then scenic element 56. Upon completing the 360-degree rotation, the control unit combines the narrow portions in the order the portions were recorded together to form the panoramic image.

Various features and advantages of the invention are set forth in the following claims.

What is claimed is:

1. A camera assembly operable to capture a surrounding scene, the camera assembly comprising:
a rotatable structure;
a motor assembly operable to rotate the rotatable structure;
a camera coupled to the rotatable structure, the camera having a lens and an imaging device configured to record a portion of the surrounding scene; and
a controller operable to control the motor assembly synchronous with the imaging device such that the linear device captures the image while the motor assembly is rotating the camera.

2. A camera assembly as claimed in claim 1, further comprising a support coupled to and supporting the motor assembly and rotatable structure.

3. A camera assembly as claimed in claim 2, wherein the motor assembly includes a motor base secured to the rotatable structure and a motor shaft secured to the support.

4. A camera assembly as claimed in claim 1, wherein the camera includes a digital camera.

5. A camera assembly as claimed in claim 1, wherein the imaging device includes a linear optical array.

6. A camera assembly as claimed in claim 5, wherein the linear optical array includes a CMOS image sensor.

7. A camera assembly as claimed in claim 1, wherein the controller is programmed to rotate the camera at least 300 degrees.

8. A camera assembly as claimed in claim 1, wherein the controller is programmed to rotate the camera about 360 degrees.

9. A camera assembly as claimed in claim 1, wherein the controller is programmed to rotate the camera at a substantially constant speed.

10. A camera assembly as claimed in claim 9, wherein the speed is 10 to 360 degrees per second.

11. A camera assembly as claimed in claim 1, wherein the amount of rotation of the camera is adjustable.

12. A camera assembly as claimed in claim 11, further comprising an indicator that determines an amount of rotation of the camera, where a position of the indicator is adjustable to change the amount of rotation of the camera.

13. A camera assembly as claimed in claim 12, further comprising a support coupled to and supporting the motor and rotatable structure, wherein the indicator is detachably coupled to the support.
